(19) United States
(12) Patent Application Publication
(10) Pub. No.: US 2009/0222603 A1
(43) Pub. Date: Sep. 3, 2009

(54) BUS COMMUNICATION SYSTEM

(75) Inventor: Gerrit W. Den Besten, Eindhoven (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/719,540

(22) PCT Filed: Nov. 14, 2005
(86) PCT No.: PCT/IB2005/053740

§ 371 Date: Apr. 17, 2009

(30) Foreign Application Priority Data
Nov. 16, 2004 (EP) 04105816.5

(51) Int. Cl. G06F 13/42

(52) U.S. Cl. 710/106

(57) ABSTRACT

The invention relates to a bus communication system for serialized data transmission comprising: a transmitter, a receiver, and a data line, whereby said transmitter is arranged for transmitting a data signal over said data line; said receiver is arranged for receiving said data signal from said data line, wherein said transmitter is arranged for transmitting an end of transmission signal over said data line after transmission of said data signal is completed; and said receiver is arranged for receiving said end of transmission signal from said data line.

The invention relates to a bus communication system as defined by the preamble of claim 1.

The invention also relates to a method of communication as defined by the preamble of claim 8, a transmitter as defined by the preamble of claim 9, and a receiver as defined by the preamble of claim 10.

Such a bus communication system is generally known. In source synchronous systems a bit-level clock signal is transmitted together with data in order to match skews and capture the data at the receive side without the need for phase-alignment circuitry. By avoiding such phase alignment circuitry the complexity of the receiver is reduced. In a source synchronous bus communication system it is not necessary to use line-coding, because there is no data sequence constraint at the receive side required to capture the data properly. An advantage is therefore that the communication overhead associated with line-coding can be avoided. However, because data is not encoded a different way to ensure data integrity is required.

Amongst others it is an object of the invention to provide a reliable data transmission between transmitter and receiver.

To this end the invention provides a communication bus system as defined in the opening paragraph, which is characterized by the characterizing portion of claim 1. By transmitting an end of transmission signal it is ensured that anything received hereafter will be discarded by the receiver thereby ensuring the integrity of the received data signal.

A method of communication as defined in the opening paragraph according to the invention is characterized by the characterizing portion of claim 8. A transmitter as defined in the opening paragraph according to the invention is characterized by the characterizing portion of claim 9. A receiver as defined in the opening paragraph according to the invention is characterized by the characterizing portion of claim 10.

The invention will be described with reference to the accompanying drawings in which:

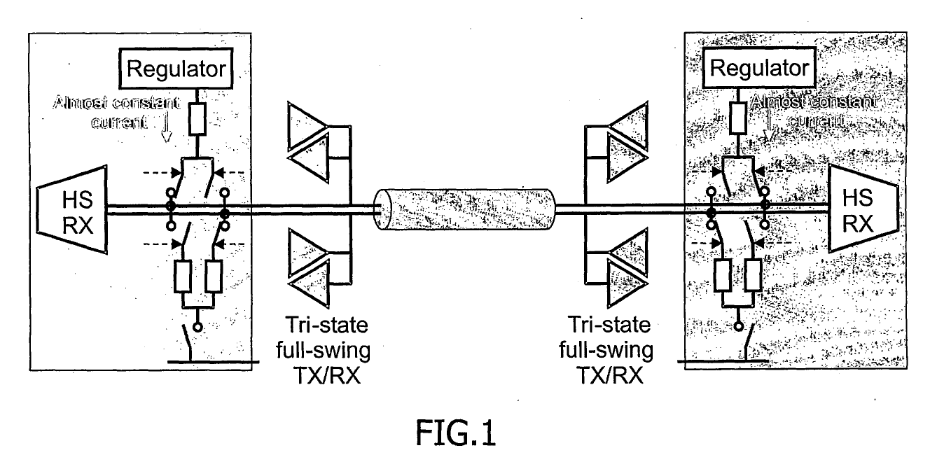

FIG. 1 shows a schematic diagram of a bus system according to the invention;

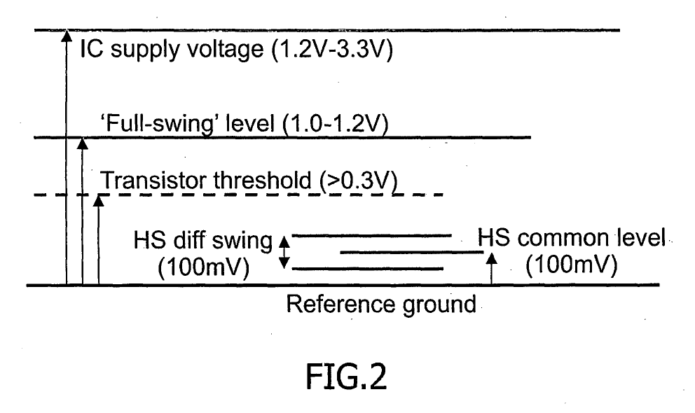

FIG. 2 shows a diagram indicating the voltage levels used in a bus system according to the invention;

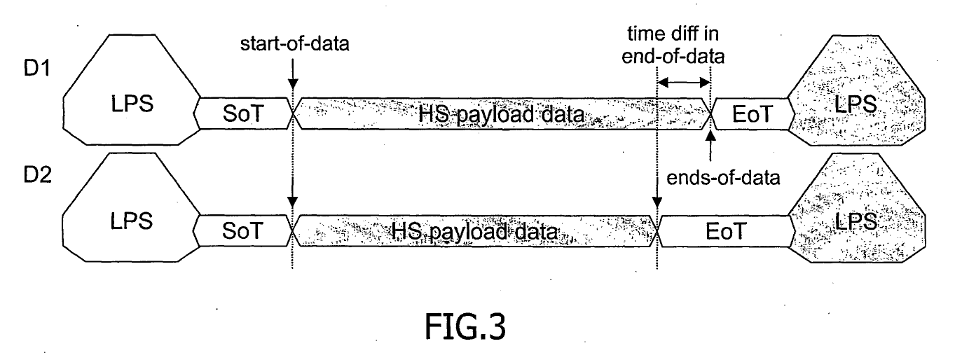

FIG. 3 shows a diagram of the generic structure of a signaling sequence in a bus system according to the invention;

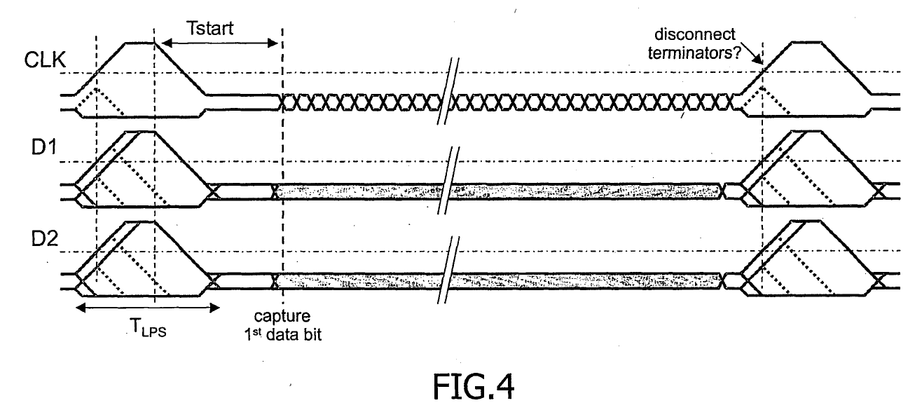

FIG. 4 shows an embodiment of a source synchronous transmission scheme for use in the bus system according to the invention;

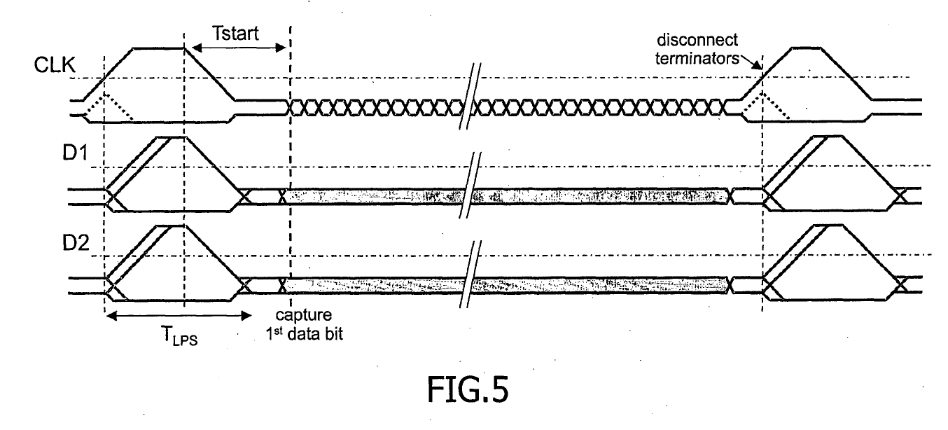

FIG. 5 shows another embodiment of a source synchronous transmission scheme for use in the bus system according to the invention;

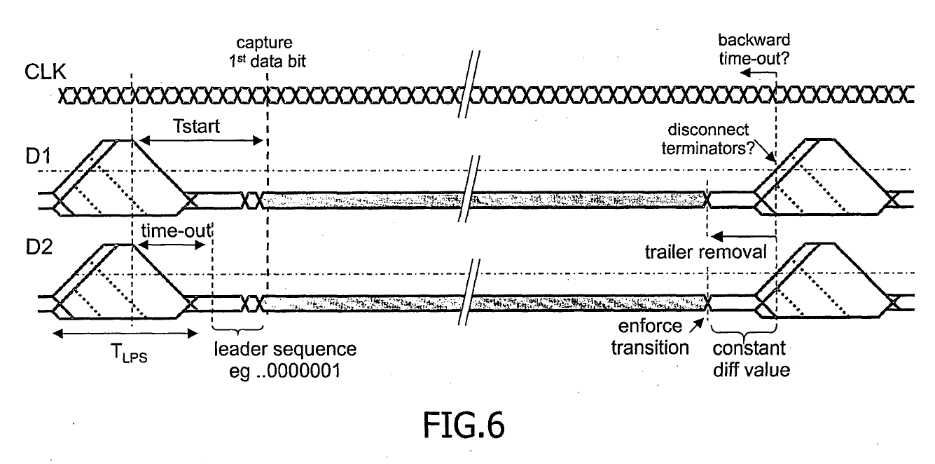

FIG. 6 shows yet another embodiment of a source synchronous transmission scheme for use in the bus system according to the invention;

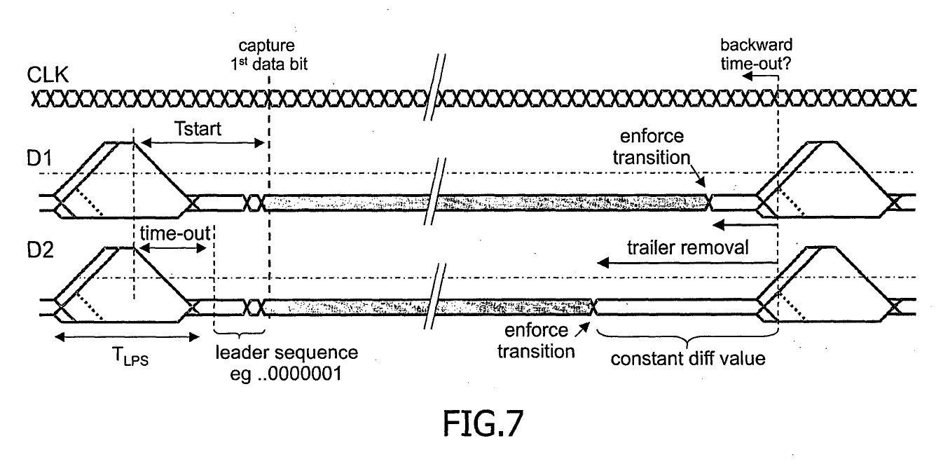

FIG. 7 shows the same embodiment of a source synchronous transmission scheme for use in the bus system according to the invention as shown in FIG. 6; and

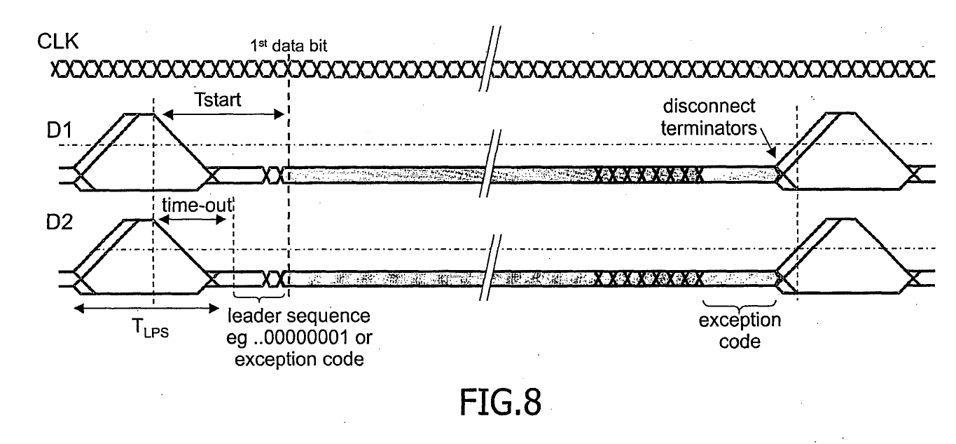

FIG. 8 shows yet another embodiment of a source synchronous transmission scheme for use in the bus system according to the invention.

In these figures identical parts are identified with identical references.

FIG. 1 shows a schematic diagram of a bus system according to the invention.

In source synchronous systems a bit-level clock signal is transmitted together with the data in order to match skews and capture the data at the receive side without the need for (complex) phase-alignment circuitry. In such a source synchronous system it is not necessary to use line encoding (which implies overhead) because there is no data sequence constraint at the receive side in order to capture the data properly. Line encodes types, which increase the number of bits in a word (for example 8B10B) implies some overhead bandwidth requirement for the electronics and the transmission channel, which is in some case not attractive. However, line encoding enables the use of exception codes for command type actions, for instance indicating end-of transmission to the receiver. See FIG. 8. Exception codes are bit sequences which do not occur within the encoded payload data words them self.

Without line encoding the payload data can contain any arbitrary sequence. Therefore it is impossible to unambiguously detect a special code within the data stream, without constraining the data space for the application protocol. For obvious reasons, the latter is in general very unattractive.

In serial transmission schemes all bits are sent sequentially. Because in most systems the fundamental word size on which operation are performed is larger than one bit. This means that a Serial-to-Parallel and Parallel-to-Serial conversion is needed and that proper alignment on the word boundaries is needed. Especially if a link must be often started and stopped it is important that this can be achieved efficiently. High overhead would reduce the attractiveness of switching modes very often and also increase latency to start-up the transmission.

The electrical signaling scheme that is assumed to support two ‘line modes’:

1. high-speed data transmission mode

2. some electrical states which are simply distinguishable from high-speed data transmission mode

The reason for the second mode can for example be to obtain ultra-low power consumption in case there is no data to be transmitted (Low Power States: LPS) Therefore it can also be used to initialize and structure the data transmission.

In an electrical layer that is proposed for MIPI (Mobile Interface Processor Interface Alliance) the high-speed transmission is assumed to be realized with an SLVS (Scalable Low-Voltage Signaling) type scheme with signals close to ground level, while in the low-power states the lines have large swing CMOS like voltage level, which can be easily separated from each other. See FIG. 1 and FIG. 2. In this particular case the difference between the differential and common-mode levels is exploited.

These different modes have (intentionally) totally different speed, which makes it impossible to switch between them without a proper mode-transition scheme. The large swing mode has far too slow edges (EMI reasons) to guarantee high-speed bit-level sync timing accuracy. Therefore at the beginning and end of transmission a special procedure is needed to guarantee the right word alignment at the start of transmission and avoid addition of invalid words at the end of transmission. See FIG. 3.

Without applying data encoding all data sequences are possible in the regular data stream, which makes it impossible to synchronize on word boundary during normal data transmission. Because the low-power state on the line before data transmission is unambiguously detectable, the synchronization at the beginning of the packet can be solved with known techniques like a time-out to overcome a period of undefined line levels combined with a high-speed start-sequence, which uniquely identifies the first data bit.

If the Clk and all Data lanes (or lines) always switch mode (almost) simultaneously and there are only Clock signal transitions when there are valid data bits on the data lanes everything becomes very straightforward. (See FIG. 4 and FIG. 5) However there are several reasons why the clock in a system will not be operated that way. For instance keeping the Clock running for some time after the end of transmission give the opportunity to process the data in the receiver using the transmitted Clock while there no data transport anymore. Multi-lane is another use case, which will be explained later in this document.

Assume now that the clock keeps running after the last valid data bit. Because the transition to a LPS after high-speed transmission is slow, it easily happens that one or more additional data words will be received and captured before LPS is detected. This would cause unintended extension of the packet with ‘random’ data. A signaling procedure has been invented to avoid this unwanted addition of unknown words.

In the bus system according to the invention after the last valid data bit a trailer sequence is added which makes it possible to detect unambiguously where the last valid data bit was.

Only after it has been detected that the line states entered a LPS it is known to the system that the transmission has ended. At that moment it should be possible to trace back what the last valid data bit (word) was.

One possible solution is to invert the high-speed signal immediately after the last data bit and then keep a constant differential value on the line till the LPS is detected. This makes it very easy to remove all equal bits from the end of the data till the last transition. This makes it even possible to detect whether the data was still properly word aligned at the end of transmission. In order to avoid electrical signaling implementation complexity a backward time-out can be applied. This means that after LPS has been detected, the data belonging to the last n clock cycles will be discarded, whereby n is chosen sufficient long to be sure that the system will have completed its transition to LPS. That way the differential value of the signal doesn't have to be guaranteed during the transition to LPS before detection, because it won't be interpreted anyway.

Removal of the trailer sequence implies some latency as it a back tracking mechanism and the triggering event is the detection of LPS.

FIG. 6 depicts an example of the situation in an abstracted way. After the command to start transmission there is a time out, which avoids interpreting the line levels during switching to transmission mode. After the time-out the line is in a well-defined transmission state. The leader sequence is such that it unambiguously determines what the first valid data bit is. The shown example “ . . . 00000001ddd . . . ” certainly does that, although alternatives are possible. Then an arbitrary amount of data is transmitted. After the last payload data bit has been transmitted the polarity of the line signal is switched and differential signal is maintained till LPS detection.

Actually any known sequence can be added to the trailer sequence as long as it can be traced-back unambiguously at the receive side. For example always add one byte after the payload data and continue the value of the last bit till LPS is detected. This can be traced back because it is known to the system that there is always one byte pattern added after the valid data followed by a continuous value.

If the byte patterns are properly chosen additional features are possible, like sync checks and choice of polarity of the last bit (which determines continued signal). For instance a proper selection of the byte patterns 00111100, 11000011, 00001111, or 11110000 can provide such a feature. It is obvious that there are numerous variations possible on this.

Although the clock will most likely not always keep running in these systems, it is necessary in some cases to continue the clock for a while. Therefore this invention was needed to solve this. Furthermore it solves another issue. If multiple data lanes are used in parallel in combination with a single bit-type clock, this invention provides a solution to end the lanes individually at different times. As a matter of fact in this multi-lane case, the clock must continue as long as there is still data on one of the lanes. This implies that if the data doesn't stop at the same time on all lanes, the clock will continue at least after valid data reception for the earliest stopped lane. See FIG. 7.

In general embedded clock systems require line encoding. The main reasons are the embedding of clock information (transition density) and/or to maintain a DC balance. For that reason it is most likely not possible to maintain the ‘no coding’ constraint for these case. An example of an alternative solution is shown in FIG. 5. Note that it is still possible to use the above described techniques to identify End-of-Transmission in Embedded Clock systems. Although, the use of exception codes may be advantageous in those cases, it is possible to use both for a double check to improve reliability.

FIG. 1 shows an example of electrical driver/receiver scheme, which provides the two line modes by combining a) a high-speed low-swing differential driver/receiver (SLVS) combination operating on (partially) terminated characteristic lines, b) together with slow low-power larger-swing drivers/receivers operating on un-terminated lines. The larger-swing receiver includes measures to reduce glitch sensitivity by performing input signal filtering combined with some comparator hysteresis. The driver in receiver RX also serves as terminator for the bus lines. The system comprises separate slew-rate controlled full-swing drivers for Low-Power Line States (LPS) including filtering and hysteresis.

FIG. 2 shows a diagram indicating the voltage levels used in a bus system according to the invention. FIG. 2 shows typical signal levels for the implementation example given in FIG. 1. High-speed signaling takes place below the MOS transistor threshold level of approximately 0.3 volt. This enables independent operation of High-speed signaling and Low-Speed signaling. The full-swing level in this example is around 1 volt. This does not imply a separate power supply is required, although this may be advantageous in some circumstances. An advantage of this level is that it enables low-power operation. Another advantage is that it ensures interoperability of technologies for a long time.

FIG. 3 shows a diagram of the generic structure of a signaling sequence in a bus system according to the invention. FIG. 3 depicts the generic structure of the signaling sequence and what the generic issues are that have to be solved. There may be one or multiple data lanes (D1, D2, . . . ) Between (high-speed) transmission periods the lines are in LPS. The edges for transition from transmission mode to LPS are pretty slow. For example a transmission line of up to 25 cm length, with 50 Ohm characteristic impedance, can have a total distributed capacitance of around 30 pF. Given a nominal charging current in the order of 1 mA (low for EMI) the transition can take tens of ns. In order to achieve proper word alignment the position of start of data has to be found unambiguously. This requires a certain Start-of-Transmission (SoT) sequence. After transmission of the payload data the line return to LPS via and End-of-Transmission (EoT) trailer sequence. The use of multiple lanes implies that each lane may end its transmission at a different moment in time. For correct communication the different EoT trailer sequences have to be distinguished by the receiver.

FIG. 4 shows an embodiment of a source synchronous transmission scheme for use in the bus system according to the invention. In a source synchronous transmission scheme as shown in FIG. 4, the (differential) clock signal only has one and only transition for every valid data bit. This appears to be very simple and attractive. An advantage is for instance that it implicitly solves the synchronization problem. On the other hand it implies restrictions for the usage of the clock signal. It should be noted that in order to disable far end line terminators the lines can be lifted in common-mode level to avoid excessive power consumption while still achieving the LPS threshold. In this scheme both clock and all data lanes are operated exactly simultaneous. In summary clock and data lines or wires switch states and modes synchronously, there are only transitions in the clock signal if there are real payload data bits present on the data lines, multi-lane data streams must be ended simultaneously—this requires increased granularity, and there is no option to disable terminators before LPS detection (no protocol involvement assumed).

FIG. 5 shows another embodiment of a source synchronous transmission scheme for use in the bus system according to the invention. The operation is similar to the case as explained in relation to FIG. 4, except that the LPS on the clock signal is slightly leading compared to the data lanes. This makes it possible to disable termination on the data lanes before bringing them in LPS, which simplifies and improves the electrical signaling scheme. This scheme still assumes the clock is stopped if there is no data available. In summary clock and data lines switch states and modes synchronously, the clock signal always leads mode transitions, there are only zero-crossings or transitions in the clock signal if there are payload data bits present on the data lines, multi-lane streams have to end simultaneous, and it is not possible to disable terminators before going to LPS.

FIG. 6 shows yet another embodiment of a source synchronous transmission scheme for use in the bus system according to the invention. In the scheme shown in FIG. 6 the clock continues running, in other words there will be transitions in the clock signal even if there are no valid data bits present on the data lines. Such mode of operation in which the clock continues running during both transmission mode and LPS of the data lanes a different word sync mechanism is required. FIG. 6 shows an example of using a enforced transition followed by a continuous differential polarity on each lane (data line). Other possibilities are explained above in the description of FIG. 1. The depicted word sync method at the beginning of transmission uses a time-out, followed by a 00000001 pattern, followed by the real payload data. In summary the clock keeps running and data lanes are sampled—except those lanes in LPS. This requires an unambiguous header (or leader) and trailer sequences to extract real data bits. Data streams at different lanes may end at different times. This method implies some latency because the trailer has to be removed after completion of the transmission. In a preferred way this removal would be done inside a PHY (Physical Layer) of a communication protocol. The indicated backward time-out ensures that after detection of the transition to LPS the last couple of bits received by the receiver are removed from the data stream. During transition to LPS it is difficult to ensure that signals remain within certain bounds. By discarding these last bits, that do not contain real data anyway, data integrity is ensured.

FIG. 7 shows the same embodiment of a source synchronous transmission scheme for use in the bus system according to the invention as shown in FIG. 6. In the scheme shown in FIG. 7 transmissions in lanes D1 and D2 end at different times.

FIG. 8 shows yet another embodiment of a source synchronous transmission scheme for use in the bus system according to the invention. This example shows how EoT detection could be solved in case of the availability of line encoding including exception codes. This simplifies the signaling scheme but implies coding overhead, which means that a higher speed and thus bandwidth will be required. For embedded clock transmission schemes this will most likely be a preferred solution. Line coding is in that case wanted for several reasons.

The embodiments of the present invention described herein are intended to be taken in an illustrative and not a limiting sense. Various modifications may be made to these embodiments by those skilled in the art without departing from the scope of the present invention as defined in the appended claims.

1. A bus communication system for serialized data transmission comprising: a transmitter, a receiver, and a data line, whereby
said transmitter is arranged for transmitting a data signal over said data line;
said receiver is arranged for receiving said data signal from said data line, characterized in that:
said transmitter is arranged for transmitting an end of transmission signal over said data line after transmission of said data signal is completed; and
said receiver is arranged for receiving said end of transmission signal from said data line.

2. A bus communication system as claimed in claim 1, characterized in that it further comprises a second data line, whereby:
said transmitter is arranged for transmitting a second data signal and a second end of transmission signal over said second data line and for transmitting a second end of transmission signal over said second data line;
said receiver is arranged for receiving said second data signal and said second end of transmission signal over said second data line.

3. A bus communication system as claimed in claim 2, characterized in that the receiver is arranged to signal an end of transmission if it has received said end of transmission signal and said second end of transmission signal.

4. A bus communication system as claimed in claim 1, characterized in that it further comprises a clock line, whereby:
said transmitter is arranged to transmit a clock signal over said clock line;
said receiver is arranged to receive said clock signal from said clock line.

5. A bus communication system as claimed in claim 1, characterized in that said data signal is a binary encoded signal comprising a sequence of first and second symbols and a transition between a first symbol and a second symbol is represented by a transition in signal level on said data line.

6. A bus communication system as claimed in claim 5, characterized in that an end of transmission signal comprises a single transition in signal level on said data line following the data signal.

7. A bus communication system as claimed in claim 1, characterized in that said end of transmission signal is followed by a transition to another communication mode allowing communication on a lower speed.

8. A method of communication for use in a bus communication system for serialized data transmission comprising: a transmitter, a receiver, and a data line, whereby
said transmitter transmits a data signal over said data line;
said receiver receives said data signal from said data line, characterized in that:
said transmitter transmits an end of transmission signal over said data line after transmission of said data signal is completed; and
said receiver receives said end of transmission signal from said data line.

9. A transmitter for used in a bus communication system for serialized data transmission comprising a transmitter, a receiver, and a data line, whereby
said transmitter is arranged to transmit a data signal over said data line, characterized in that said transmitter is arranged to transmit an end of transmission signal over said data line after transmission of said data signal is completed.

10. A receiver for use in a bus communication system for serialized data transmission comprising a transmitter, a receiver, and a data line, whereby
said receiver is arranged for receiving a data signal from said data line, characterized in that:
said receiver is arranged for receiving an end of transmission signal over said data line after reception of said data signal is completed.
